(19) United States
(12) Patent Application Publication
(10) Pub. No.: US 2011/0039581 A1
(43) Pub. Date: Feb. 17, 2011

(54) Method and apparatus for restricting the use of a mobile telecommunications device by a vehicle's driver

(76) Inventors: Yigang Cai, Naperville, IL (US); Ranjan Sharma, New Albany, OH (US); Shengqiang Wang, Raleigh, NC (US)

Correspondence Address: Alcatel-Lucent USA, Inc.;Docket Administrator - Room 2F-192, 600-700 Mountain Avenue, Murray Hill, NJ, 07974-0636, US

(21) Appl. No.: 12/462,963

(22) Filed: Aug. 12, 2009

(51) Int. Cl. H04W 24/00

(52) U.S. Cl. 455/456.4

(57) ABSTRACT

A method and apparatus which determines that a vehicle operator is in physical possession of a given mobile telecommunications device and that the vehicle is moving at a speed greater than a given threshold speed (which may be zero), and thereby restricts the use of the mobile communications device. Illustratively, the device may be restricted from placing and receiving calls, and sending and receiving text messages. It may be determined that the vehicle operator is in physical possession of the device based on near field communication (NFC) technology whereby a Radio Frequency Identification (RFID) transceiver is attached to or embedded in the steering wheel or driver's seat of the vehicle. The vehicle's speed may be determined using a Global Positioning System (GPS) receiver or an Assisted GPS (A-GPS) technique, or from speed data determined by the vehicle itself and communicated to the mobile communications device thereby.

### FIELD OF THE INVENTION

The present invention relates generally to the field of mobile telecommunications devices such as cellular telephones and more specifically to a method and apparatus for restricting the use of such a device by the driver of a vehicle such as an automobile.

### BACKGROUND OF THE INVENTION

A leading cause of automobile accidents, especially of accidents involving teenage drivers, is the use of a mobile communication device (e.g., a cell phone) while driving the vehicle. It is not uncommon to find young drivers distracted by an incoming call or a short (text) message. It is also no longer surprising to see drivers initiating a text message while behind the wheel.

A number of states in the U.S. have legislated a requirement that only hands-free mobile telecommunications devices may be used by the driver of an automobile. However, while the use of hands-free devices can reduce the occurrence of accidents caused by cell phone use, a complete elimination of such accidents is still not possible with the use of such devices, since it is a proven fact that using any cell phone—hands-free or not—while driving a vehicle is a major source of distraction. Moreover, many drivers, and especially teenage drivers, often ignore such legislation.

Although various approaches to address this problem have been proposed, none of these prior art approaches provide an adequate mechanism for reducing the risk of accidents without simultaneously imposing unreasonable limitations to the use of mobile communications devices in an automobile. Therefore, such an appropriately measured approach is clearly needed.

### SUMMARY OF THE INVENTION

The current inventors have recognized that the only practical approach to eliminating the risk of accidents caused by the use of mobile telecommunications devices by automobile drivers (and other vehicle operators) is to specifically restrict the use of such devices by the vehicle operator and only the vehicle operator whenever the vehicle is in motion (or, is moving at a speed above a given threshold speed). Any such technique which also does not permit the use of mobile telecommunications devices by others (i.e., non-drivers, such as, for example, vehicle passengers) will not be acceptable and thus will not be adopted.

As such, in accordance with various illustrative embodiments of the present invention, a method and apparatus is provided which determines that the vehicle operator (himself or herself) is in physical possession of a given mobile telecommunications device and that the vehicle is moving at a speed greater than a given threshold speed (which, in accordance with certain illustrative embodiments of the present invention, may be zero). Then, upon such a determination, use of the given mobile communications device (and only the given mobile communications device) is advantageously restricted. For example, in accordance with one illustrative embodiment, the mobile telecommunications device may be restricted from placing calls, receiving calls, sending a text message and/or receiving a text message.

In accordance with various illustrative embodiments of the present invention, it may be determined that the vehicle operator is in physical possession of the given mobile telecommunications device based on the use of a near field communication technique such as Radio Frequency Identification (RFID) technology, wherein an RFID transceiver may be advantageously attached to or embedded in either the steering wheel or the driver's seat of the vehicle. In addition, in accordance with various illustrative embodiments of the present invention, it may be determined that the vehicle is moving at a speed greater than the given threshold speed with use of a Global Positioning System (GPS) receiver or an Assisted GPS (A-GPS) technique, or based on current speed data determined by the vehicle itself which is communicated to the mobile communications device thereby.

More specifically, in accordance with one illustrative embodiment of the present invention, a method for restricting use of a mobile telecommunications device in a vehicle having an operator comprises determining that (i) the operator of the vehicle is currently in physical possession of the mobile telecommunications device and (ii) the vehicle is currently in motion and moving at a speed which is above a given threshold speed; and restricting the mobile telecommunications device from performing one or more functions thereof if it has been determined that (i) the operator of the vehicle is currently in physical possession of the mobile telecommunications device and (ii) the vehicle is currently in motion and moving at a speed which is above the given threshold speed.

Similarly, in accordance with another illustrative embodiment of the present invention, a mobile telecommunications device adapted to restrict its own use in a vehicle having an operator thereof comprises a processor which: determines that (i) the operator of the vehicle is currently in physical possession of the mobile telecommunications device and (ii) the vehicle is currently in motion and moving at a speed which is above a given threshold speed; and restricts the mobile telecommunications device from performing one or more functions thereof if it has been determined that (i) the operator of the vehicle is currently in physical possession of the mobile telecommunications device and (ii) the vehicle is currently in motion and moving at a speed which is above the given threshold speed.

And also, in accordance with still another illustrative embodiment of the present invention, a network element for restricting use of a mobile telecommunications device in a vehicle having an operator thereof, the network element comprised in a mobile telecommunications network, comprises a processor which: determines that (i) the operator of the vehicle is currently in physical possession of the mobile telecommunications device and (ii) the vehicle is currently in motion and moving at a speed which is above a given threshold speed; and restricts the mobile telecommunications device from performing one or more functions thereof if it has been determined that (i) the operator of the vehicle is currently in physical possession of the mobile telecommunications device and (ii) the vehicle is currently in motion and moving at a speed which is above the given threshold speed.

### BRIEF DESCRIPTION OF THE DRAWINGS

FIG. 1 shows an illustrative environment in an automobile in which the principles of the present invention may be advantageously employed in accordance with one illustrative embodiment of thereof.

FIG. 2 shows an illustrative environment in an automobile in which the principles of the present invention may be advantageously employed in accordance with another illustrative embodiment of thereof.

FIG. 3 shows a flowchart of a method for restricting the use of a mobile telecommunications device by the driver of a vehicle in accordance with one illustrative embodiment of the present invention.

FIG. 4 shows a flowchart of a method for restricting the use of a mobile telecommunications device by the driver of a vehicle in accordance with another illustrative embodiment of the present invention.

FIG. 5 shows a block diagram of a portion of a mobile telecommunications device in accordance with one illustrative embodiment of the present invention.

FIG. 6 shows a block diagram of a portion of a network element of a mobile telecommunications network in accordance with another illustrative embodiment of the present invention.

FIG. 7 shows an illustrative frame of a Link Access Procedure, D Channel (LAPD) communication as may be transmitted from a mobile telecommunications to a mobile telecommunications network in support of an illustrative method for restricting the use of a mobile telecommunications device by the driver of a vehicle in accordance with other illustrative embodiments of the present invention.

### DETAILED DESCRIPTION OF THE ILLUSTRATIVE EMBODIMENTS

In accordance with various illustrative embodiments of the present invention, the defensive restrictions (DR) which may be advantageously imposed on a mobile communications device include a temporary removal of the phone's capability to originate a voice call; a temporary removal of the phone's capability to receive a voice call; a temporary removal of the phone's capability to send a text message; and/or a temporary removal of the phone's capability to receive a text message. Moreover, in accordance with these illustrative embodiments of the present invention, one or more of the following advantageous characteristics are satisfied:

1. The driver's phone's capability is advantageously restricted when the vehicle is moving (or moving at a speed above a given threshold);

2, There may be one or more passengers in the car whose phones advantageously remain operative as usual (i.e., the DR does not apply to these phones);

3. If the driver borrows a phone from a passenger, while driving the car, the DR advantageously becomes applicable to the borrowed phone in a moving car;

4. If the driver returns a previously borrowed phone to a passenger in the moving vehicle, the DR advantageously is removed from the device;

5. When a driver becomes a passenger and a passenger assumes the role of a driver, the DR is advantageously applied to the driver's phone and removed from the former driver's phone;

6. The vehicle in question need not belong to the driver. In other words, the vehicle may be a rental car, or may belong to a friend or a family member, or may be owned by the driver—advantageously, no distinction is made based on vehicle ownership;

7. The driver of the car may use the phone as a normal phone when the car is not moving (e.g., when the driver is just sitting in a stopped car) without any DR; and/or

8. Even under DR, the driver may be advantageously permitted to use the phone for placing emergency calls (“E911” in the United States).

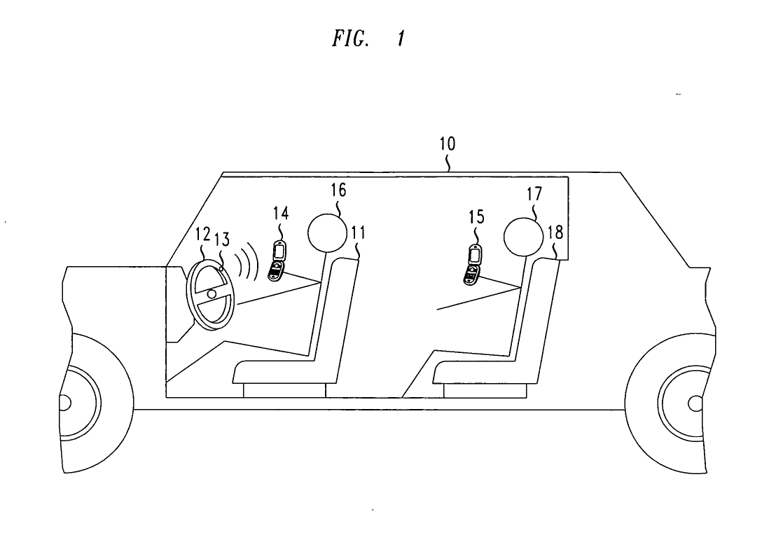

FIG. 1 shows an illustrative environment in an automobile in which an illustrative embodiment of the present invention may be advantageously employed. In particular, the figure shows the interior of illustrative automobile 10, which comprises steering wheel 12, driver's seat 11, and one or more passenger seats 18. In accordance with the illustrative embodiment of the present invention, driver 16 is seated in driver's seat 11, and driver 16 has in his or her possession cell phone 14. In addition, the illustrative environment shown in the figure includes passenger 17 seated in passenger seat 18, who has in his or her possession cell phone 15. In accordance with the principles of the present invention and in accordance with the illustrative embodiment thereof shown in the figure, Radio Frequency Identification (RFID) transceiver 13 is advantageously attached to or embedded into steering wheel 12.

In an illustrative operation of an illustrative embodiment of the present invention which employs the illustrative environment of FIG. 1, RFID transceiver 13 advantageously uses near field communication techniques, fully familiar to those of ordinary skill in the art, to enable cell phone 14 (or the mobile communications network to which cell phone 14 is connected) to determine that cell phone 14 is in the possession of driver 16, rather than in the possession of passenger 17 (or any other passenger). Thus, in accordance with the principles of the present invention and in accordance with such an illustrative embodiment of the present invention, the use of cell phone 14 may be advantageously restricted (in appropriate circumstances—for example, when it is has also been determined that the automobile is in motion and moving at a speed which is above a given threshold speed).

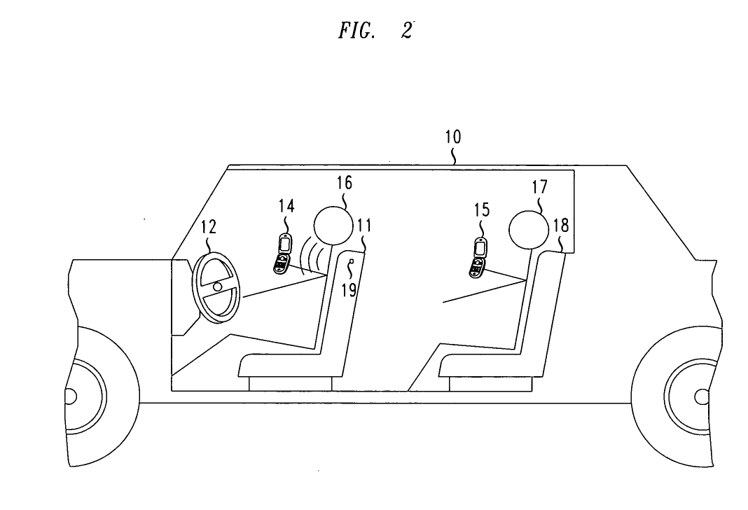

FIG. 2 shows an illustrative environment in an automobile in which the principles of the present invention may be advantageously employed in accordance with another illustrative embodiment of thereof. As in the illustrative environment shown in FIG. 1, the figure shows the interior of illustrative automobile 10, which comprises steering wheel 12, driver's seat 11, and one or more passenger seats 18. In accordance with the illustrative embodiment of the present invention, driver 16 is seated in driver's seat 11, and driver 16 has in his or her possession cell phone 14. In addition, the illustrative environment shown in the figure includes passenger 17 seated in passenger seat 18, who has in his or her possession cell phone 15. In accordance with the principles of the present invention and in accordance with the illustrative embodiment thereof shown in this figure, Radio Frequency Identification (RFID) transceiver 19 is advantageously attached to or embedded into driver's seat 11 (e.g., into the head restraint thereof).

In an illustrative operation of an illustrative embodiment of the present invention which employs the illustrative environment of FIG. 2, RFID transceiver 19 advantageously uses near field communication techniques, fully familiar to those of ordinary skill in the art, to enable cell phone 14 (or the mobile communications network to which cell phone 14 is connected) to determine that cell phone 14 is in the possession of driver 16, rather than in the possession of passenger 17 (or any other passenger). Thus, in accordance with the principles of the present invention and in accordance with such an illustrative embodiment of the present invention, the use of cell phone 14 may be advantageously restricted (in appropriate circumstances—for example, when it is has also been determined that the automobile is in motion and moving at a speed which is above a given threshold speed).

Specifically, note that the illustrative environments of FIG. 1 and FIG. 2 each advantageously leverage the driver's proximity to the steering wheel or to the head restraint on the driver's seat, respectively, in order to enable restrictions to be applied to a cell phone which is specifically in the possession of the vehicle's driver, and not to any cell phones in the possession of any passengers. The driver is closest to the steering wheel or the head restraint on the driver's seat whenever other passengers ride with the vehicle. Note also that the choice of a near field communication (NFC) technique such as that employed by RFID technology is advantageous in comparison to, for example, Bluetooth (BT) technology for at least the following reasons:

1. NFC set-up is nearly instantaneous and avoids BT set-up delays.

2. NFC is compatible with existing RFID infrastructure.

3. NFC has a shorter range and is therefore better suited for correlating devices in crowded spaces. This is especially advantageous here since it is conceivable that all the passengers in the vehicle, as well as the driver, may be carrying a mobile communications device.

As is well known by those of ordinary skill in the art, one type of RFID technology is passive RFID technology, and a special case of that is battery-assisted passive RFID technology, wherein the RFID transceiver is advantageously silent without the battery power. Thus, in accordance with one illustrative embodiment of the present invention, a battery-assisted passive RFID transceiver may be advantageously coupled to a vehicle's ignition such that it will transmit a signal only when the vehicle's ignition is on. Therefore, a cell phone in the possession of a vehicle occupant (whether it is the driver or not) will advantageously fail to detect the nearby presence of the RFID transceiver when the vehicle's ignition is off.

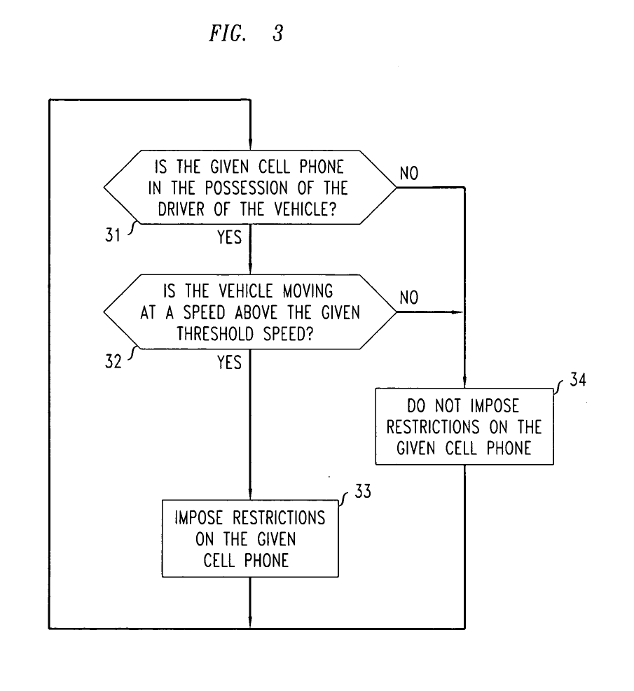

FIG. 3 shows a flowchart of a method for restricting the use of a mobile telecommunications device by the driver of a vehicle in accordance with one illustrative embodiment of the present invention. The illustrative method of FIG. 3 may, for example, be performed at least in part by a cell phone (i.e., a mobile telecommunications device) which is in the possession of the driver of the vehicle. In particular, the illustrative method first determines whether the given cell phone is, in fact, in the possession of the driver. (See flowchart block 31.) Illustratively, this may be done by determining whether a given RFID transceiver—which may, for example, be attached to or embedded in either the steering wheel or the driver's seat—is in close proximity to the given cell phone. If the given cell phone is not in the possession of the driver, the given cell phone's operation will not be not restricted and flow returns to the beginning so that the need to restrict the cell phone's operation may be advantageously monitored on a continuous basis. (See flowchart block 34.)

If, on the other hand, the given cell phone is determined to be in the possession of the driver, the illustrative method next determines whether the vehicle is currently in motion and moving at a speed which is above a given threshold speed (which may, for example, be equal to zero). (See flowchart block 32.) Illustratively, the speed of motion of the vehicle (or lack of motion thereof) may, for example, be determined with use of a Global Positioning System (GPS) receiver or an Assisted GPS (A-GPS) technique, or from current speed data determined by the vehicle itself and communicated to the cell phone thereby. If it is determined that the vehicle is not currently in motion or not moving at a speed which is above the given threshold speed (if any), the given cell phone's operation will not be restricted and flow returns to the beginning so that the need to restrict the cell phone's operation may be advantageously monitored on a continuous basis. (See flowchart block 34.)

If, on the other hand, the vehicle is determined to be currently in motion and moving at a speed which is above the given threshold speed (if any), restrictions are imposed on the operation of the given cell phone. (See flowchart block 33.) Illustratively, such restrictions may include the prohibition of one or more of the functions of placing a call, receiving a call, sending a text message and receiving a text message. Moreover, these restrictions may, for example, be imposed on the cell phone with use of application software running on the cell phone itself. Upon imposing the restrictions on the operation of the cell phone, flow returns to the beginning so that the need to restrict the cell phone's operation may be advantageously monitored on a continuous basis.

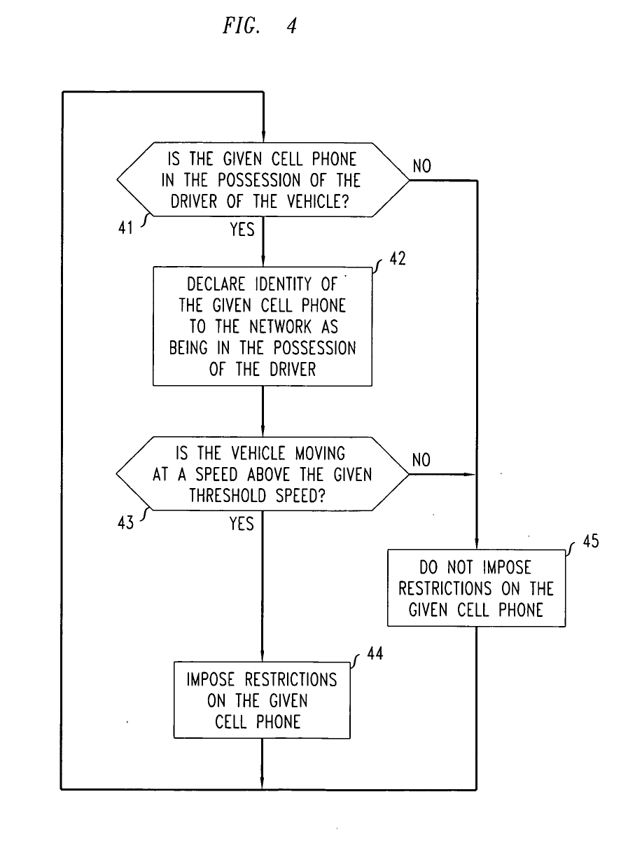

FIG. 4 shows a flowchart of a method for restricting the use of a mobile telecommunications device by the driver of a vehicle in accordance with another illustrative embodiment of the present invention. The illustrative method of FIG. 4 may, for example, be performed at least in part within a mobile telecommunications network. In particular, the illustrative method first determines whether the given cell phone is, in fact, in the possession of the driver. (See flowchart block 41.) Illustratively, this may be done by determining whether a given RFID transceiver—which may, for example, be attached to or embedded in either the steering wheel or the driver's seat—is in close proximity to the given cell phone. If the given cell phone is not in the possession of the driver, the given cell phone's operation will not be not restricted and flow returns to the beginning so that the need to restrict the cell phone's operation may be advantageously monitored on a continuous basis. (See flowchart block 45.)

If, on the other hand, the given cell phone is determined to be in the possession of the driver, the illustrative method next declares the identity of the driver's cell phone to the mobile communications network to which it is connected. (See flowchart block 42.) Thus, the mobile communications network is advantageously aware of the fact that the given cell phone is in the possession of a driver of a vehicle.

Then, as the next step, the illustrative method determines whether the vehicle is currently in motion and moving at a speed which is above a given threshold speed (which may, for example, be equal to zero). (See flowchart block 43.) Illustratively, the speed of motion of the vehicle (or lack of motion thereof) may, for example, be determined within the mobile telecommunications network with use of an Assisted GPS (A-GPS) technique, a common feature of cellular communications networks. (In accordance with other illustrative embodiments of the present invention, the speed of motion of the vehicle or lack thereof may be determined with use of a GPS receiver or from current speed data determined by the vehicle itself and communicated to the cell phone thereby.) If it is determined that the vehicle is not currently in motion or not moving at a speed which is above the given threshold speed (if any), the given cell phone's operation will not be restricted and flow returns to the beginning so that the need to restrict the cell phone's operation may be advantageously monitored on a continuous basis. (See flowchart block 45.)

If, on the other hand, the vehicle is determined to be currently in motion and moving at a speed which is above the given threshold speed (if any), restrictions are imposed on the operation of the given cell phone. (See flowchart block 44.) Illustratively, such restrictions may include the prohibition of one or more of the functions of placing a call, receiving a call, sending a text message and receiving a text message. Moreover, these restrictions may, for example, be imposed on the cell phone by the mobile telecommunications network by preventing, for example, the establishment of a call and/or text message service thereto. Upon imposing the restrictions on the operation of the cell phone, flow returns to the beginning so that the need to restrict the cell phone's operation may be advantageously monitored on a continuous basis.

As pointed out above, in accordance with various illustrative embodiments of the present invention, one alternative to the use of GPS or A-GPS technology is that the RFID transceiver (which is advantageously attached to or embedded in the steering wheel or the driver's seat in the vehicle) may be advantageously integrated with the vehicle's computer system (present in most automobiles currently available) to obtain the vehicle's speed information and to transmit this information to the driver's cell phone. Such an approach advantageously allows for an illustrative implementation of the present invention whereby a client-centric architecture, implemented on the mobile phone itself as an application, provides the capability. In accordance with such an illustrative embodiment of the present invention, the application on the cell phone advantageously receives information from the vehicle's computer which indicates the speed of the vehicle. Then, when the speed is more than the given threshold (which may be equal to zero, or illustratively, may instead be either 5 or 10 MPH, for example), the application advantageously forces a break of the communication between the phone and the mobile communications network. (In accordance with certain illustrative embodiments of the present invention, “E911” emergency calls may be allowed as a single exception.)

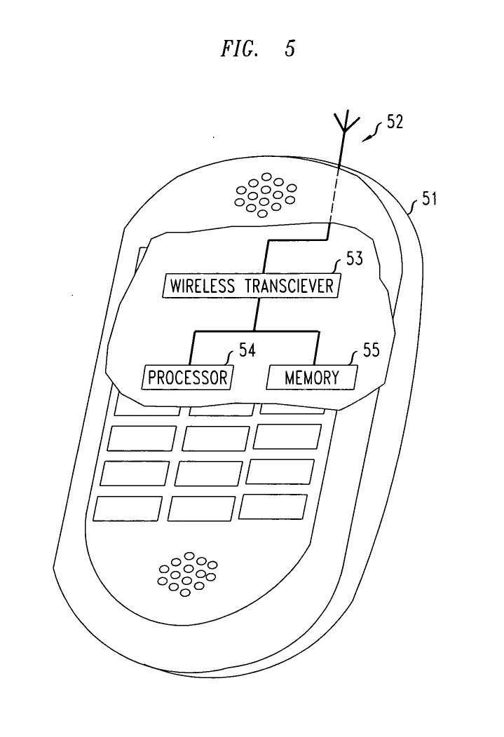

FIG. 5 shows a block diagram of a portion of a mobile telecommunications device in accordance with one illustrative embodiment of the present invention. The figure shows cell phone 51 having antenna 52, as well as several functional blocks representing a portion of the internal workings of the device. Specifically, antenna 52 is internally connected to wireless transceiver 53, which transmits and receives data (information) via antenna 52. In addition, the device advantageously includes processor 54 and memory 55 which together enable the device to effectuate various illustrative embodiments of the present invention.

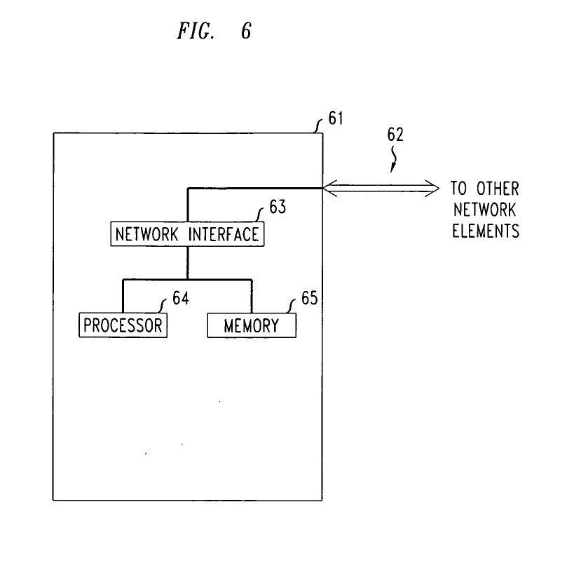

FIG. 6 shows a block diagram of a portion of a network element of a mobile telecommunications network in accordance with another illustrative embodiment of the present invention. The figure shows network element 61, which is interconnected via network connection 62 to other network elements in the given mobile telecommunications network (e.g., cellular network). Specifically, network connection 62 is internally connected to network interface 63, which transmits to and receives data (information) from other network elements via network connection 62. In addition, the device advantageously includes processor 64 and memory 65 which together enable the device to effectuate various illustrative embodiments of the present invention.

Note that in accordance with various illustrative embodiments of the present invention, there are a number of different types of implementations which may be effectuated, including, at least:

(a) a client-centric approach, which may be advantageously implemented on an application running on the mobile telecommunications device itself;

(b) a network-centered approach, which may advantageously make use of information from within the mobile telecommunications (e.g., cellular) network and which then advantageously imposes the defensive restrictions (DR) within the network; and

(c) a hybrid approach, where the functionality is advantageously distributed between the client (i.e., the mobile communications device) and the network.

The following is a detailed description of certain illustrative embodiments employing such a hybrid approach, which illustratively use a cellular network employing either Code Division Multiple Access (CDMA) or Global System for Mobile Communications (GSM) cellular technology, each of which is fully familiar to those of ordinary skill in the art. First of all, note that a cellular device communicates with the wireless network via base stations (also know as base transceiver stations—BTS, and base station subsystem, or BSS), and on to mobile switching centers (MSCs). The air (wireless) interface exists between the mobile device and the BTS. A protocol commonly used for this air interface is known as Link Access Procedure, D Channel (LAPD), which is also fully familiar to those of ordinary skill in the art, and is based on International Telecommunications Union standards ITU-T Q.920 and ITU-T Q.921 (which are also fully familiar to those of ordinary skill in the art).

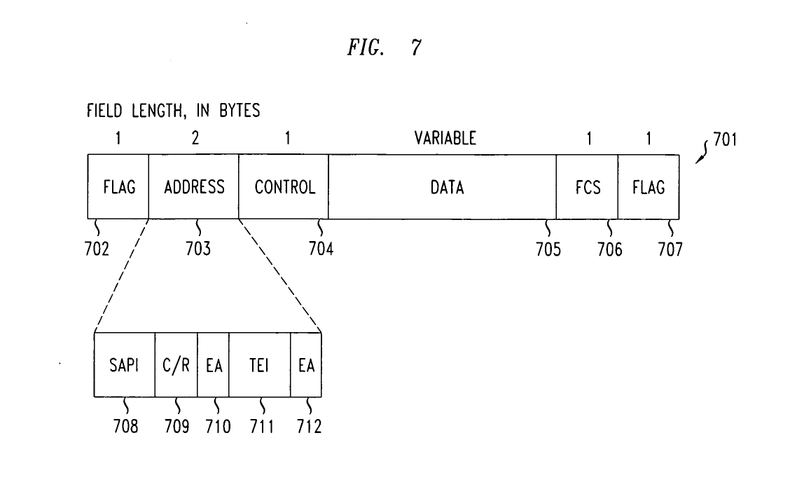

FIG. 7 shows an illustrative frame of a Link Access Procedure, D Channel (LAPD) communication as may be transmitted from a mobile telecommunications to a mobile telecommunications network in support of an illustrative method for restricting the use of a mobile telecommunications device by the driver of a vehicle in accordance with other illustrative embodiments of the present invention. In particular, LAPD frame 701, as shown in the figure, has a structure which comprises Flag field 702 (consisting of one byte of data), Address field 703 (consisting of two bytes of data), Control field 704 (consisting of one byte of data), Data field 705 (consisting of a variable number of bytes of information), which is used in frames carrying higher-layer data, Frame check sequence 706 (consisting of one byte of data), and Flag field 707 (consisting of one byte of data), which comprises identical data to Flag field 702. In addition, Address field 703, as shown in the figure, has a structure which comprises Service access point identifier 708, Command/response bit 709, Extended addressing bits 710 and 712, and Terminal endpoint identifier 711.

In accordance with various ones of these illustrative embodiments of the present invention, a cellular service provider may offer a “service” which incorporates an ability to impose restrictions on the use of a cell phone by the driver of a vehicle when the vehicle is in motion (above a given threshold speed). Subscribers to such a service may be either (a) “selective,” in which case, trigger points may be advantageously associated with their Home Location Register (HLR) profile, with the effect that only those subscribers would experience additional processing while initiating or receiving a call, or (b) “across the board,” in which case a general mechanism like an “all call query” would be employed and result in additional processing for all calls.

Note that in accordance with various ones of such illustrative embodiments of the present invention, the association of “triggers” may be static, as in case of provisioning the HLR, or the triggers may be armed dynamically, with the advantage that only mobile phones identified as being in the possession of a vehicle's driver, or moving mobile phones identified as being in the possession of a vehicle's driver, would be subjected to extra processing. Both static and dynamic arming of triggers are well known to those of ordinary skill in the art.

Now consider a moving vehicle's driver having in his or her possession a mobile phone which is subscribed to the illustrative service. As is well known to those of ordinary skill in the art, as the vehicle moves through the wireless coverage area, the mobile device attaches to a BTS associated with a specific “cell.” In the course of movement, the association between the device and a given BTS may change via prevalent hand-off techniques, all of which are fully familiar to those of ordinary skill in the art. In accordance with the principles of the present invention, however, and in accordance with certain various illustrative embodiments thereof, whenever a new BTS communicates with the mobile device, the mobile device advantageously informs the BTS that the mobile device belongs to (i.e., is in the possession of) the vehicle's driver. Advantageously, this may, for example, be done using the LAPD frame's information part (i.e., Data filed 705 as shown in FIG. 7), and this process may, for example, be initiated as a result of the detection of a nearby RFID transceiver (which is attached to or embedded in either the vehicle's steering wheel or the driver's seat) interacting with the mobile phone. In particular, the mobile device may so inform the BTS by advantageously making use of the “information” part of an LAPD frame to carry this “declarative” information to the network.

Specifically, these illustrative embodiments of the present invention may provide this “declarative” information to the network in a number of ways—two such illustrative approaches advantageously extend the LAPD protocol (as shown in FIG. 7) by expanding the use of Control field 704. In prior art cellular systems, the control field is typically 1 byte (although it is 2 bytes in some cases), and conveys information relating to whether or not the receiver is ready, whether a rejection has resulted, or else some other (structured) information. Two such specific illustrative approaches are:

1. The control field is advantageously extended to be able to carry a specific bit-string that indicates to the BTS that the coverage establishment is for a mobile device in the possession of a vehicle's driver. For this purpose, we illustratively choose to employ the unnumbered format (U-Format) Control Field meant for carrying UI (Unnumbered Information), and we illustratively choose bit string “000P0111”. (The specific formats of the control field of LAPD frames, such as U-format and I-format, are fully familiar to those of ordinary skill in the art.) The choice of the bit string to be used for this purpose may be advantageously made based on the set of bit strings already in use for existing purposes. Thus, in accordance with other illustrative embodiments of the present invention, numerous other choices of bit strings which are not already in use for some other purpose—each of which will be obvious to those of ordinary skill in the art—may be employed instead of the specific bit string specified above.

2. Alternatively, the information may be advantageously carried in the Information Format (I-Format) Control field as 2 octets, using the 7 most significant bits in each octet to represent, for example, the characters “D” and “R” in 7-bit ASCII format. (“DR” is illustratively used to stand for “Driving Restrictions”.)

In either of the above cases, it may be advantageously assumed that the BTS communicates with the BSS and then with the MSC, and that appropriate flags are advantageously set in the HLR to indicate that the mobile device in question is in the possession of a vehicle driver and therefore may be under restrictions. Illustratively, this may be effectuated with use of an additional proprietary flag used in the HLR profile for the user device. In addition, the mobile phone's middleware may advantageously register the fact that the phone belongs to the driver of the vehicle.

Next, movement of the phone (i.e., of the vehicle) is advantageously established. This may be effectuated in a number of ways, including, for example:

1. The application on the mobile device may advantageously query the network about its own location twice in succession, spaced over, for example, 30 seconds, in order to establish phone movement; or

2. The vehicle may advantageously provide a linkage to the RFID transceiver to determine the vehicle's speed by communicating with an on-board computer in the vehicle; or

3. The RFID transceiver may advantageously communicate with the vehicle's own GPS-based navigation system (available on increasingly larger number of cars); or

4. Some combination of the above methods, each of which will be obvious to those of ordinary skill in the art, may be used.

As described above, when the cell phone is found to be non-stationary and traveling at a speed greater than a given threshold speed (which may, illustratively, be zero, 5 or 10 MPH, or any other appropriately chosen speed, and which may advantageously be a configurable value), then restrictions are advantageously imposed on the phone's operation by the network.

When such restrictions have been imposed on the phone (by the network), the handset (i.e., cell phone) may advantageously confirm this fact to the BTS by sending a confirmatory message via one of the two methods for providing “declarative” information to the network as described above:

1. It may advantageously employ the unnumbered format (U-Format) Control Field meant for carrying UI (Unnumbered Information) and choose, for example, bit string “000P1111”.

2. It may advantageously carry the information in the Information Format (I-Format) Control field as 2 octets, using the 7 most significant bits in each octet to represent the characters “R” and “C” in 7-bit ASCII format. (“RC” is illustratively used to stand for “Restrictions Confirmed”.)

In either of these cases, we again advantageously assume that the BTS communicates with the BSS and then with the MSC, and that appropriate flags are set in the HLR to indicate that the mobile device in question is now, in fact, under restrictions. In addition, the mobile phone's middleware may advantageously register the fact that the cell phone belongs to the driver of the vehicle and that the phone (i.e., the vehicle) is moving (at a speed greater than the threshold speed).

In accordance with one illustrative embodiment of the present invention, when a cell phone's middleware has established that the phone is in the possession of the driver of a vehicle and that the vehicle is moving (above the threshold speed), it may advantageously enter a restricted functionality mode where it displays “Emergency calls only,” and may advantageously not accept any user key inputs that are not indicative of placing such an emergency call (“911” in the US). In such a case, call origination to any non-emergency number or the sending of any text messages advantageously becomes impossible under these circumstances. In addition, in accordance with one illustrative embodiment of the present invention, any call (e.g., to a non-emergency number) which is already in progress may be advantageously terminated by the cell phone.

Moreover, in accordance with these illustrative embodiments of the present invention, since the network itself has imposed restrictions on the cell phone, no calls or text messages will be received by the cell phone. In addition, in accordance with one illustrative embodiment of the present invention, any call (e.g., to a non-emergency number) which is already in progress may be advantageously terminated by the network. That is, in accordance with this illustrative embodiment of the present invention, once both “DR” (Driving Restrictions) and “RC” (Restrictions Confirmed), or their equivalents, have been received by the network from the given cell phone but there is a call already in progress by the phone, that call will be advantageously cut off (i.e., terminated). This may occur, for example, when a call is made to or from the given cell phone when the vehicle is stationary (or moving at or below the given threshold speed), and then, the vehicle begins to move (above the given threshold speed).

In particular (and as is fully familiar to those of ordinary skill in the art), note that in typical cellular networks different “triggers” are used in the MSC for the call origination and the call termination side of the two halves of the basic call state model (BCSM). Thus, in accordance with these illustrative embodiments of the present invention, for cell phones that have corresponding flags set in the HLR with a value indicative of the fact that restrictions have been imposed thereupon (such as, for example, “000?1110”), call termination to such devices would advantageously not be possible, since the assumption is that the MSC is actively monitoring for the trigger occurrence on the terminating side.

In accordance with one such illustrative embodiment of the present invention, the HLR may, for example, advantageously instruct the MSC to forward the call to a covering extension via a conditional call-forwarding technique, which will be familiar to those of ordinary skill in the art. And, in accordance with one such illustrative embodiment of the present invention, the cell phone with DR applied may be advantageously capable of receiving a text message, although it advantageously may not alert the driver that a message has been received until after the DR has been removed from the phone.

Finally, if the vehicle stops (or slows to a speed which is not above the given threshold speed), or if the driver hands his or her mobile device to a passenger (thereby making it no longer in his or her possession), then, in accordance with the principles of the present invention and in accordance with various illustrative embodiments thereof, the device advantageously becomes fully operative once again. In particular, if the mobile phone becomes out of reach of the RFID transceiver (which would be the case if, for example, the driver passes the phone to another person—i.e., a passenger—in the vehicle), or if the vehicle is no longer moving (or moving but not above the threshold speed), then, in accordance with certain ones of these illustrative embodiments of the present invention, the phone middleware may advantageously once again communicate with the BTS providing coverage, and, in particular, may use one of the above described methods for communicating “declarative” information to the network as described above:

1. It may advantageously employ the unnumbered format (U-Format) Control Field meant for carrying UI (Unnumbered Information) and choose, for example, bit string “000P1011”.

2. It may advantageously carry the information in the Information Format (I-Format) Control field as 2 octets, using the 7 most significant bits in each octet to represent the characters “R” and “R” in 7-bit ASCII format. (“RR” is illustratively used to stand for “Restrictions Removed”.)

In either case, this approach advantageously allows the BTS/BSS to communicate the status change to the MSC/HLR, and therefore the restrictions may be advantageously removed. However, in the case of the vehicle coming to a stop (or slowing to a speed which is not above the given threshold speed), then, in accordance with one illustrative embodiment of the present invention, a “time delay” may be advantageously imposed prior to the removal of the restrictions. In this manner, when a vehicle stops (briefly) at an intersection (e.g., at a red light or stop sign), or when a vehicle is driving in stop-and-go traffic, the restrictions will not be removed only to have them quickly imposed again. In particular, the time delay may be applied at the cell phone, wherein, for example, the “RR” (Restrictions Removed) or equivalent declaration to the network is not made until a sufficient time has elapsed (and then, only if the vehicle has not started to move again), or the time delay may be applied in the network, wherein, for example, the network does not act on the “RR” (Restrictions

Removed) or equivalent declaration by the cell phone until a sufficient time has elapsed (and then, only if vehicle has not started to move again, thereby beginning the imposition of a new restriction).

### Addendum to the Detailed Description

The preceding merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams included herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

A person of ordinary skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as magnetic disks and magnetic tapes, hard drives, or optically readable digital data storage media. The embodiments are also intended to cover computers programmed to perform said steps of the above-described methods.

The functions of any elements shown in the figures, including functional blocks labeled as “processors” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof any element expressed as a module which performs a specified task is intended to encompass any way of performing that task including, for example, a) a combination of circuit elements which performs that task or b) software in any form, including, therefore, firmware, microcode or the like, combined with appropriate circuitry for executing that software to perform the task. The invention as defined by such claims resides in the fact that the functionalities provided by the various recited modules are combined and brought together in the manner which the claims call for. Applicant thus regards any mechanisms which can provide those tasks as being equivalent to those shown herein. Note in particular that the use of such modules which perform a task as specified in the instant claims is specifically intended not to be deemed a “means for” performing a given function, as permitted by and interpreted in accordance with 35 U.S.C. 112, paragraph 6.

In particular and moreover, in accordance with various illustrative embodiments of the present invention, the determination “that (i) the operator of the vehicle is currently in physical possession of the mobile telecommunications device and (ii) the vehicle is currently in motion and moving at a speed which is above a given threshold speed,” as recited in certain ones of the instant claims may, for example, be effectuated by a physical mechanism which makes such a determination, or may merely be effectuated by a mechanism which receives information that such a determination has been made. For example, as recited in claims directed to a “mobile communications device,” this mechanism may, in accordance with one illustrative embodiment of the present invention, simply be effectuated by a wireless receiver included in the device which receives information (from an external source) relating to the location of the device (e.g., that “the operator of the vehicle is currently in physical possession of the mobile telecommunications device”) and/or to the motion of the vehicle (e.g., that “the vehicle is currently in motion and moving at a speed which is above a given threshold speed”). Similarly, as recited in claims directed to a “network element comprised in a mobile telecommunications network,” this mechanism may, in accordance with one illustrative embodiment of the present invention, simply be effectuated by a module of the network element which receives information (from an external source) relating to the location of the device (e.g., that “the operator of the vehicle is currently in physical possession of the mobile telecommunications device”) and/or to the motion of the vehicle (e.g., that “the vehicle is currently in motion and moving at a speed which is above a given threshold speed”).

What is claimed is:

1. A method for restricting use of a mobile telecommunications device in a vehicle, the vehicle having an operator thereof, the method comprising:
determining that (i) the operator of the vehicle is currently in physical possession of the mobile telecommunications device and (ii) the vehicle is currently in motion and moving at a speed which is above a given threshold speed; and
restricting the mobile telecommunications device from performing one or more functions thereof if it has been determined that (i) the operator of the vehicle is currently in physical possession of the mobile telecommunications device and (ii) the vehicle is currently in motion and moving at a speed which is above the given threshold speed.

2. The method of claim 1 wherein said determining that the driver of the vehicle is currently in physical possession of the mobile telecommunications device is based on use of a near field communication technique.

3. The method of claim 2 wherein said determining that the driver of the vehicle is currently in physical possession of the mobile telecommunications device is based on use of a Radio Frequency Identification (RFID) transceiver.

4. The method of claim 3 wherein the vehicle is an automobile having a steering wheel, and wherein the RFID transceiver is attached to or embedded in the steering wheel of the vehicle.

5. The method of claim 3 wherein the vehicle has a driver's seat in which the operator of the vehicle sits, and wherein the RFID transceiver is attached to or embedded in the driver's seat of the vehicle.

6. The method of claim 1 wherein the given threshold speed is zero.

7. The method of claim 1 wherein the one or more functions of the mobile telecommunications device which are restricted from being performed includes one or more of the functions of placing a call, receiving a call, sending a text message and receiving a text message.

8. The method of claim 7 wherein the one or more functions of the mobile telecommunications device which are restricted from being performed includes the function of placing any calls except for emergency “E911” calls, and wherein said placing of said emergency “E911” calls are not restricted.

9. The method of claim 1 further comprising terminating restrictions of the mobile telecommunications device when it is determined that the operator of the vehicle is no longer in physical possession of the mobile telecommunications device.

10. The method of claim 1 further comprising terminating restrictions of the mobile telecommunications device when it is determined that the vehicle is no longer in motion or no longer moving at a speed which is above the given threshold speed.

11. The method of claim 1 wherein said determining that the vehicle is currently in motion and moving at a speed which is above a given threshold speed is based on use of a Global Positioning System (GPS) receiver or on use of an Assisted GPS (A-GPS) technique.

12. The method of claim 1 wherein said determining that the vehicle is currently in motion and moving at a speed which is above a given threshold speed is based on current speed data determined by the vehicle and communicated to the mobile communications device thereby.

13. The method of claim 1 wherein said restricting the mobile telecommunications device from performing one or more functions thereof is effectuated by the mobile telecommunications device.

14. The method of claim 1 wherein said restricting the mobile telecommunications device from performing one or more functions thereof is effectuated by one or more network elements comprised within a mobile telecommunications network.

15. A mobile telecommunications device adapted to restrict its own use in a vehicle, the vehicle having an operator thereof, the mobile telecommunications device comprising a processor which:
determines that (i) the operator of the vehicle is currently in physical possession of the mobile telecommunications device and (ii) the vehicle is currently in motion and moving at a speed which is above a given threshold speed; and
restricts the mobile telecommunications device from performing one or more functions thereof if it has been determined that (i) the operator of the vehicle is currently in physical possession of the mobile telecommunications device and (ii) the vehicle is currently in motion and moving at a speed which is above the given threshold speed.

16. The mobile telecommunications device of claim 15 further comprising a wireless receiver which receives information from an external source indicating that (i) the operator of the vehicle is currently in physical possession of the mobile telecommunications device and/or (ii) the vehicle is currently in motion and moving at a speed which is above a given threshold speed, and wherein the processor determines that (i) the operator of the vehicle is currently in physical possession of the mobile telecommunications device and (ii) the vehicle is currently in motion and moving at a speed which is above a given threshold speed based at least in part on said receipt of said information by said wireless receiver.

17. The mobile telecommunications device of claim 15 wherein the determination that the operator of the vehicle is currently in physical possession of the mobile telecommunications device is based on use of a near field communication technique.

18. The mobile telecommunications device of claim 17 wherein the determination that the driver of the vehicle is currently in physical possession of the mobile telecommunications device is based on a detection of a nearby presence of a Radio Frequency Identification (RFID) transceiver.

19. The mobile telecommunications device of claim 15 wherein the given threshold speed is zero.

20. The mobile telecommunications device of claim 15 wherein the one or more functions of the mobile telecommunications device which are restricted from being performed includes one or more of the functions of placing a call, receiving a call, sending a text message and receiving a text message.

21. The mobile telecommunications device of claim 20 wherein the one or more functions of the mobile telecommunications device which are restricted from being performed includes the function of placing any calls except for emergency “E911” calls, and wherein said placing of said emergency “E911” calls are not restricted.

22. The mobile telecommunications device of claim 15 wherein restrictions of the mobile telecommunications device are terminated when it is determined that the operator of the vehicle is no longer in physical possession of the mobile telecommunications device.

23. The mobile telecommunications device of claim 15 wherein restrictions of the mobile telecommunications device are terminated when it is determined that the vehicle is no longer in motion or no longer moving at a speed which is above the given threshold speed.

24. The mobile telecommunications device of claim 15 wherein the determination that the vehicle is currently in motion and moving at a speed which is above a given threshold speed is based on use of a Global Positioning System (GPS) receiver or use of an Assisted GPS (A-GPS) technique.

25. The mobile telecommunications device of claim 15 wherein the determination that the vehicle is currently in motion and moving at a speed which is above a given threshold speed is based on current speed data determined by the vehicle and communicated to the mobile communications device thereby.

26. A network element comprised in a mobile telecommunications network, the network element for use in restricting use of a mobile telecommunications device in a vehicle, the vehicle having an operator thereof, the network element comprising a processor which:
determines that (i) the operator of the vehicle is currently in physical possession of the mobile telecommunications device and (ii) the vehicle is currently in motion and moving at a speed which is above a given threshold speed; and
restricts the mobile telecommunications device from performing one or more functions thereof if it has been determined that (i) the operator of the vehicle is currently in physical possession of the mobile telecommunications device and (ii) the vehicle is currently in motion and moving at a speed which is above the given threshold speed.

27. The network element of claim 26 wherein the processor receives information from an external source indicating that (i) the operator of the vehicle is currently in physical possession of the mobile telecommunications device and/or (ii) the vehicle is currently in motion and moving at a speed which is above a given threshold speed, and wherein the processor determines that (i) the operator of the vehicle is currently in physical possession of the mobile telecommunications device and (ii) the vehicle is currently in motion and moving at a speed which is above a given threshold speed based at least in part on said receipt of said information from said external source.

28. The network element of claim 26 wherein the given threshold speed is zero.

29. The network element of claim 26 wherein the one or more functions of the mobile telecommunications device which are restricted include one or more of the functions of placing a call, receiving a call, sending a text message and receiving a text message.

30. The network element of claim 26 wherein the one or more functions of the mobile telecommunications device which are restricted include the function of placing any calls except for emergency “E911” calls, and wherein said placing of said emergency “E911” calls are not restricted.

31. The network element of claim 26 wherein restrictions of the mobile telecommunications device are terminated if it is determined that the operator of the vehicle is no longer in physical possession of the mobile telecommunications device.

32. The network element of claim 26 wherein restrictions of the mobile telecommunications device are terminated if it is determined that the vehicle is no longer in motion or no longer moving at a speed which is above the given threshold speed.

33. The network element of claim 26 wherein the determination that the vehicle is currently in motion and moving at a speed which is above a given threshold speed is based on use of a Global Positioning System (GPS) receiver or with use of an Assisted GPS (A-GPS) technique.
